(19) United States
(12) Patent Application Publication
(10) Pub. No.: US 2018/0251178 A1
(43) Pub. Date: Sep. 6, 2018

(54) BICYCLE SAFETY DEVICE

(71) Applicant: David Sawyer Arms, Winter Park, FL (US)

(72) Inventor: David Sawyer Arms, Winter Park, FL (US)

(21) Appl. No.: 15/686,439

(22) Filed: Aug. 25, 2017

Related U.S. Application Data
(60) Provisional application No. 62/466,842, filed on Mar. 3, 2017.

(51) Int. Cl. B62J 6/04; B60Q 1/30; B60Q 1/26

(52) U.S. Cl. CPC B62J 6/04; B60Q 1/2657; B60Q 1/2615; B60Q 1/30

(57) ABSTRACT

A bicycle safety device includes an elongated support pole having a connection unit along a bottom end, and an illumination unit along the top end. The connection unit includes any number of clamps or brackets for securing the device onto a bicycle. The illumination unit includes any number of lighting elements for producing continuous or flashing beams of visible light 360 degrees about the pole. A power unit provides the necessary power requirements to the lighting unit. A light shield is positioned beneath the illumination unit, and a spring is positioned between the pole and the connection unit.

### CROSS-REFERENCE TO RELATED APPLICATIONS

This application claims the benefit of U.S. Application Ser. No. 62/466,842 filed on Mar. 3, 2017, the contents of which are incorporated herein by reference.

### TECHNICAL FIELD

The present invention relates generally to safety devices, and more particularly to a safety device for providing a visual indication of the location of a bicyclist.

### BACKGROUND

The statements in this section merely provide background information related to the present disclosure and may not constitute prior art.

When riding a bicycle in low light situations, it is imperative that passing vehicles be able to clearly identify the location of the bicyclist to avoid an accident. This is especially true when the rider is low to the ground, as is common with children riding small bikes, or adults riding a recumbent bicycle, for example.

There are many types of existing safety devices such as reflective markers, and reflective vests, for example, which function to reflect light to alert passing vehicles to the presence of a bicyclist. Unfortunately, as these devices are passive in nature, the vehicle must already be in close proximity to the bicycle before the devices can illuminate. Additionally, there are various types of headlight devices which can be secured onto the handlebars of a bicycle, in order to illuminate the path in front of the bicyclist. Unfortunately, use of such devices has the effect of ruining the night vision of the rider, causing them to be unable to see anything but the small patch of illuminated area directly in front of the bicycle. As such, many accidents have occurred wherein the bicyclist hits low hanging tree branches, and/or are struck by other objects coming at them from the side.

As such, it would be beneficial to provide a raised bicycle safety device that can provide an active visual alert along a 360 degree area about a bicyclist, without affecting the night vision of the rider and without suffering from the drawbacks described above.

### SUMMARY OF THE INVENTION

The present invention is directed to a bicycle safety device. One embodiment of the present invention can include an elongated support pole having a connection unit along a bottom end, and an illumination unit along the top end. The connection unit can include any number of clamps or brackets for securing the device onto a bicycle. The illumination unit can include any number of light producing elements for producing continuous or flashing beams of visible light 360 degrees about the pole. A power unit can house batteries and can provide the necessary power requirements to the lighting unit.

In one embodiment of the present invention the device can include a light shield that is positioned beneath the illumination unit. The light shield can function to prevent the light produced by the illumination unit from reaching the rider of a bicycle to which the device is secured, thus preventing their night vision from being affected.

In another embodiment, the device can include a spring which can function as a shock absorber for preventing damage to the device during operation.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a side view of a bicycle safety device that is useful for understanding the inventive concepts disclosed herein.

FIG. 2 is a side view of the bicycle safety device in accordance with one embodiment of the invention.

FIG. 3 is a side view of the bicycle safety device in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Although described and illustrated for use with a bicycle, those of skill in the art will recognize that the inventive concepts disclosed herein can be utilized with other types of devices and/or in other industries. Accordingly, the device is not to be construed as limited to use with a bicycle.

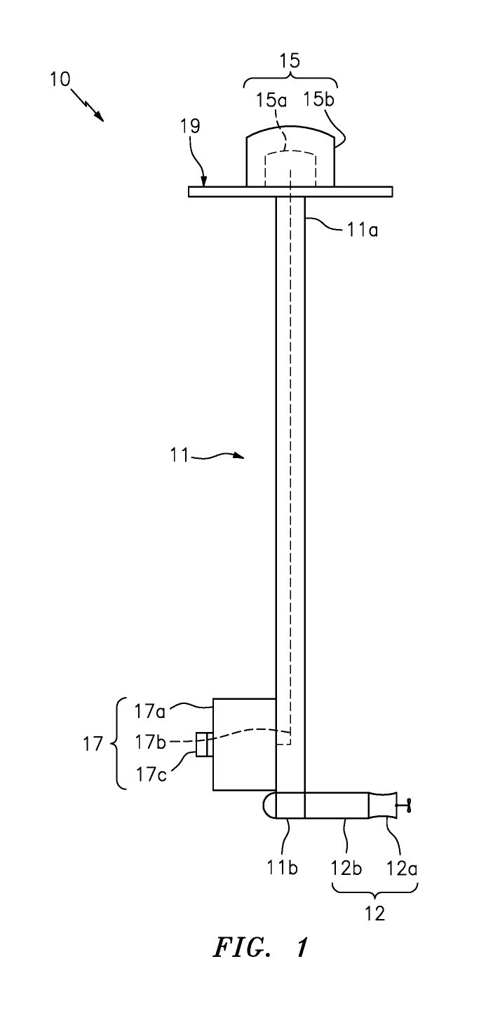

FIGS. 1-3 illustrate one embodiment of a bicycle safety device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

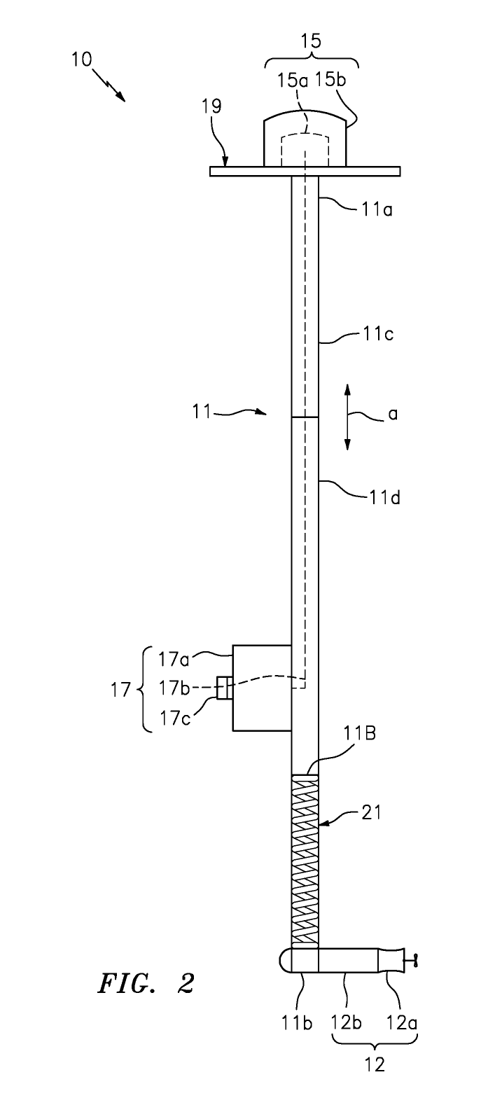

As shown in FIGS. 1 and 2, the device 10 can include a support pole 11, a connection unit 12; an illumination unit 15; a power unit 17, a light shield 19, and an optional spring 21.

The support pole 11 can include an elongated member having a top end 11a, and a bottom end 11b. The pole can be constructed from any number of generally lightweight and stiff materials such as various metals, metal alloys and/or plastics, for example.

In the preferred embodiment, the pole can comprise a single 3 foot aluminum rod, which is sufficient to position the illumination unit above the head of an average height adult male sitting on a bicycle seat; however, other sizes and materials are contemplated. For example, other embodiments of the support pole 11 can be constructed from multiple individual segments 11c and 11d, for example, that can be sequentially joined together and/or telescopically connected to form a single elongated pole having a length that can be varied by the end user (see arrow a).

The connection unit 12 can function to secure the pole 11 onto a bicycle or other such object in either a permanent or removable manner. As described herein, the term “removably secured” and derivatives thereof shall be used to describe a situation wherein two or more objects are joined together in a non-permanent manner so as to allow the same objects to be repeatedly joined and separated. This can be accomplished through the use of any number of commercially available connectors 12a such as compression fittings, brackets, clamps (e.g., quick release clamps, saddle post clamps, etc.,) and the like. Moreover, the term “permanently secured” shall be used to describe a situation wherein two or more objects are joined together in a manner so as to prevent the same objects from being separated. Several nonlimiting examples include various adhesives such as glue or resin, hardware such as nuts and bolts, and welds, for example. In various embodiments, the connection unit can also include an extension member 12b, such as a rod or plate, for example, that can provide lateral separation between the connector 12a and the support pole 11.

The illumination unit 15 can preferably be secured along the top end of the pole 11a, so as to be positioned above the head of a person riding the bicycle to which the device is secured. The lighting unit can include any number of different light producing elements 15a, such as light emitting diodes (LED), for example, which can be selectively illuminated to generate a strobe effect and/or solid light in any number of different colors and intensities.

The illumination unit can also include a generally transparent housing 15b for shielding the lighting elements from adverse weather conditions and/or impacts with foreign objects, while allowing the light produced by the lighting elements to be visible along a 360 degree field of view. Of course the lighting unit is not limited to the use of LED's, as any type and number of light producing element(s) can be utilized herein. Several nonlimiting examples include compact fluorescent, incandescent, and/or halogen, for example. Moreover, the transparent housing can include any number of different shapes, sizes and colors, for example.

The power unit 17 can function to provide the necessary power requirements to the lighting unit 15. In the preferred embodiment the power unit can include a weatherproof housing 17a for receiving any number of batteries therein. The batteries can be electrically connected to the illumination unit via wires 17b that can be routed through the pole 11. In various embodiments, the power unit can also include a controller having a switch 17c for transitioning the lighting unit between an ON and OFF operating state and/or for transitioning the lighting unit to perform a lighting effect such as constant illumination or to blink, for example. Such features can be augmented and/or accomplished through the use of one or more internal microprocessors (not illustrated), for example.

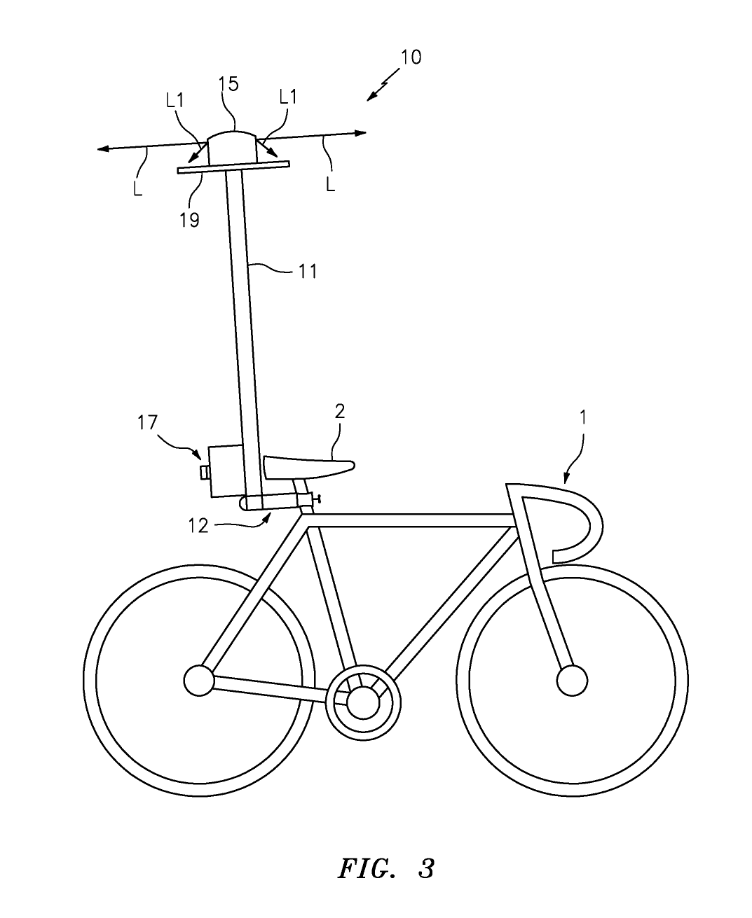

The light shield 19 can include a generally opaque member that is positioned along the pole 11 at a location directly beneath the illumination unit 15. As shown, the shield 19 can include a shape/footprint that is larger than that of the illumination unit, and can function to prevent light produced by the unit from shining downward (See FIG. 3).

To this end, it is preferred that the shield include a dimension/diameter that is at least two times larger than a dimension/diameter of the illumination unit so as to ensure that the light produced by the illumination unit does not affect the night vision of a user riding the bicycle to which the device 10 is secured. As described herein, the shield 19 can preferably be constructed from an enlarged disc of non-transparent plastic, for example, however other materials are also contemplated.

As shown in FIG. 2, the device 10 can also include a spring 21 or other resilient device that is interposed between the pole 11 and the connection unit 12. The spring can function as a shock absorber to prevent the bumps and vibrations commonly encountered while riding a bicycle from affecting the electronic components of the lighting unit 15 and/or power unit 17. Moreover, the spring can function to reduce the deleterious effects which may be caused by a collision between the device 10 and foreign objects such as tree branches, for example.

FIG. 3 illustrates one embodiment of the device 10 in operation. As shown, the device can be secured onto a bicycle 1 via the connection unit 12, preferably at a location behind the bicycle seat 2. Once positioned thereon, the lighting unit 15 can be illuminated to produce a clear 360 degree beam of light L that can be seen from vehicles approaching the bicycle from any direction. Moreover, the shield 19 can prevent light L1 from shining downward and reducing the night vision of the bicycle rider.

Although not illustrated, any number of accessory items can also be provided, such as a carrying case or bag, for example, that can function to store the device when not in use on the bicycle.

As described herein, one or more elements of the bicycle safety device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A bicycle safety device, comprising:
an elongated pole having a top end, a bottom end and an internal channel;
a connection unit that is secured along the bottom end of the elongated pole, said connection unit being configured to engage a bicycle;
an illumination unit that is secured along the top end of the elongated pole; and
a power unit that is in electrical communication with the illumination unit.

2. The device of claim 1, further comprising a spring that is interposed between the bottom end of the pole and the connection unit.

3. The device of claim 1, wherein the illumination unit includes at least one lighting unit that is positioned within a transparent housing, said lighting unit and housing functioning to produce a visible beam of light along a 360 degree area relative to the pole.

4. The device of claim 1, wherein the power unit includes a switch that is configured to selectively activate the illumination unit.

5. The device of claim 1, wherein the elongated pole comprises a single aluminum rod having a length that is sufficient to position the illumination unit above a head of an adult user sitting on a bicycle seat of the bicycle to which the device is secured.

6. The device of claim 1, wherein the elongated pole comprises at least two segments that are telescopically connected.
